(19) United States
(12) Patent Application Publication
(10) Pub. No.: US 2017/0151890 A1
(43) Pub. Date: Jun. 1, 2017

(54) Replacement Motor Controller Kit for Retrofitting Electric Golf Cart

(71) Applicants: Willem Jager, Cambridge (CA); Gang Pan, Waterloo (CA)

(72) Inventors: Willem Jager, Cambridge (CA); Gang Pan, Waterloo (CA)

(21) Appl. No.: 14/953,080

(22) Filed: Nov. 27, 2015

(51) Int. Cl. B60L 15/20; B60L 7/10; B60L 11/18

(52) U.S. Cl. CPC B60L 15/20; B60L 11/18; B60L 7/10; B60L 2200/22

(57) ABSTRACT

A kit for retrofitting a golf cart having wheels driven by an electric motor. The kit includes a replacement motor controller for operating the electric motor. The replacement motor controller includes memory for storing motor operation limits corresponding to the golf cart. A driving parameter programmer is in communication with the replacement motor controller for selecting one or more driving parameters including: acceleration limit; speed limit; regenerative braking limit; and vehicle range. The replacement motor controller adjusts a motor control profile in real-time based on selection of the driving parameter, and the replacement motor controller maintains the motor control profile within the motor operation limits stored in the memory.

### TECHNICAL FIELD

The embodiments herein relate to motor controllers for driving electric vehicles such as golf carts. More particularly, the embodiments herein relate to kits for retrofitting electric golf carts with replacement motor controllers.

### INTRODUCTION

The following paragraphs are not an admission that anything discussed in them is prior art or part of the knowledge of persons skilled in the art.

Electric golf carts and other electric vehicles have wheels driven by electric motors. The motors are controlled using onboard motor controllers, which often have pre-configured settings to provide certain driving characteristics (e.g. high power and short range, or vice versa). In some cases, specific settings may be selected based on expected operating conditions likely to be encountered by the vehicle. For example, some manufactures might assume the vehicle will be driven in average conditions by drivers having average skill.

In some applications, a fixed set of operating parameters can work well. For example, rental golf carts used to transport golfers and clubs around golf courses typically have well-known loads and consistent driving conditions. Some golf course managers might also request vehicles with pre-set limits on speed and acceleration. This might help to accommodate drivers with average driving skill.

In other applications, fixed operating parameters might not be appropriate. For example, some individual golfers might purchase their own golf cart and those golfers might wish to modify operating parameters to provide specific performance levels. Furthermore, some golf carts have a bimodal life cycle. For example, a rental golf cart might initially be used to transport golfers and clubs around a public golf course. After a few years, the golf cart might be re-purposed as an electric utility vehicle (e.g. for grounds-keeping purposes), or as another small task-oriented vehicle. Re-purposing the golf cart might involve the addition of larger wheels and a corresponding increase to output power applied to the motors. In each of these circumstances, it can be desirable to modify operating parameters for the electric motors.

Traditionally, when operating parameters are modified, someone will either: (a) replace the motor controller entirely (e.g. to provide a new controller with higher output power), or (b) re-program the existing motor control using sophisticated equipment (e.g. using an expensive computer). In both cases, a golf cart is often returned to a dealer where a specialist will perform the modifications. These specialists often rely upon significant knowledge and expertise to avoid improper tuning of the controller, which could otherwise cause damage to components of the golf cart such as the batteries or the motors. The need for specialized knowledge can make modifications quite difficult and costly, especially if operating parameters are changed multiple times during a vehicle's lifespan.

### SUMMARY

According to some embodiments, there is a kit for retrofitting a golf cart that has wheels driven by at least one electric motor. The kit includes a replacement motor controller for operating the electric motor. The replacement motor controller includes memory for storing motor operation limits corresponding to the golf cart. A driving parameter programmer is in communication with the replacement motor controller for selecting a driving parameter that includes at least one of: acceleration limit; speed limit; regenerative braking limit; and vehicle range. The replacement motor controller adjusts a motor control profile in real-time based on selection of the driving parameter, and the replacement motor controller maintains the motor control profile within the motor operation limits stored in the memory.

The adjustments to the motor control profile may include adjustments to motor current and motor voltage. The adjustments to the motor current may include at least one of: armature current and stator current. The adjustments to the motor voltage may include at least one of: armature voltage and stator voltage.

The replacement motor controller may have a separately excited motor configuration and the adjustments to the motor current may include adjustments to a ratio of armature current and stator current.

The motor control profile may include a three-dimensional variable field map that is a function of speed limit, armature current, and stator current.

The motor operation limits stored on the replacement motor controller may include at least one of: (a) motor current limits, and (b) motor voltage limits.

The replacement motor controller may adjust the motor control profile over a time period to maintain the motor control profile within the motor operation limits. For example, the motor controller may monitor power consumption over a time period and may adjust the motor control profile to maintain the motor control profile within the motor operation limits based on the power consumption detected over the time period.

The kit may include a communication module for connecting the replacement motor controller and the driving parameter programmer to the golf cart. The communication module may be selected from one of a plurality of communication modules. Each of the plurality of communication modules may have a wiring harness adapter for connection with a wiring harness of a particular golf cart. The communication module may include a wireless communication device for remotely selecting the driving parameter. The communication module may include a connector for providing four-wheel drive capability.

The kit may include a lock-out device for restricting adjustments to the driving parameter.

The replacement motor controller may be configured to provide operational feedback as at least one of: (a) visible information, and (b) audible information.

The replacement motor controller may be configured to output battery level information as at least one of: (a) visible information, and (b) audible information.

The replacement motor controller may monitor for a low battery level, and may adjust the motor control profile to reduce power consumption when the low battery level is detected.

According to some embodiments, there is a method of controlling a golf cart having wheels driven by at least one electric motor. The method includes identifying motor operation limits corresponding to the golf cart; and selecting a driving parameter that includes at least one of: acceleration limit, speed limit, regenerative braking limit, and vehicle range. The method also includes generating an adjustable motor control profile to operate the electric motor within the motor operation limits; and applying the motor control profile in real-time.

The driving parameter may be selectable within a continuous range in real-time while driving the golf cart.

The motor control profile may adjusts at least one of motor current and motor voltage.

According to some embodiments, there is a method for calibrating a motor controller of an electric golf cart. The method includes receiving throttle range data corresponding to operation of a throttle on the golf cart; receiving brake range data corresponding to operation of a brake on the golf cart; determining motor operation limits for the golf cart based on the throttle range data and the brake range data; and determining a selection range for a driving parameter based on the motor operation limits, the driving parameter including at least one of: acceleration limit, speed limit, regenerative braking limit, and vehicle range. The method also includes storing the selection range for the driving parameter on the motor controller.

The method may include selecting a calibration mode for either: (a) a series motor; or (b) a separately excited motor.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a side elevation view of a golf cart;

FIG. 2 is a perspective view of a replacement motor controller kit for retrofitting the golf cart of FIG. 1 according to one embodiment;

FIG. 3 is a top plan view of a driving parameter programmer of the kit of FIG. 2;

FIG. 4 is a side perspective view of a replacement motor controller of the kit of FIG. 2;

FIG. 5 is a top plan view of another driving parameter programmer according to another embodiment;

FIG. 6 is a flow chart depicting a method of controlling a golf cart according to another embodiment; and

FIG. 7 is a flow chart depicting a method of calibrating a replacement motor controller according to another embodiment.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed below that is not claimed in this document may be the subject matter of another protective instrument, for example, a continuing patent application, and the applicants, inventors or owners do not intend to abandon, disclaim or dedicate to the public any such invention by its disclosure in this document.

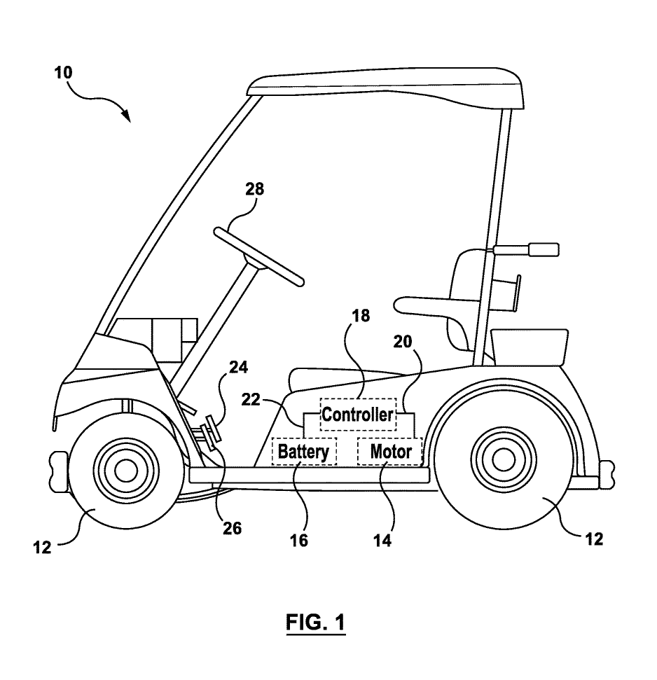

Referring to FIG. 1, there is an electric golf cart 10. The golf cart 10 has wheels 12 driven by one or more electric motors 14 such as traction motors. In some examples, the golf cart 10 may have one set of wheels 12 powered (e.g. front-wheel drive or rear-wheel drive). In other examples, the golf cart 10 may have multiple sets of wheels 12 powered (e.g. all-wheel drive). The electric motors 14 may be powered by one or more batteries 16 and may be controlled by a motor controller 18.

The motor controller 18 may be an onboard computing device and may have a microprocessor. The motor controller 18 may also have various inputs and outputs for controlling the motors 14 and other aspects of the golf cart 10. For example, the controller 18 may have a first set of terminals connected to the motor 14 (e.g. via a first set of wires 20), and a second set of terminals connected to the battery 16 (e.g. via a second set of wires 22). The controller 18 may also receive input information from other components of the golf cart 10 such as the throttle 24, brake 26, key switch, and steering wheel 28. Connections to these inputs may be made using a wiring harness (not shown in FIG. 1).

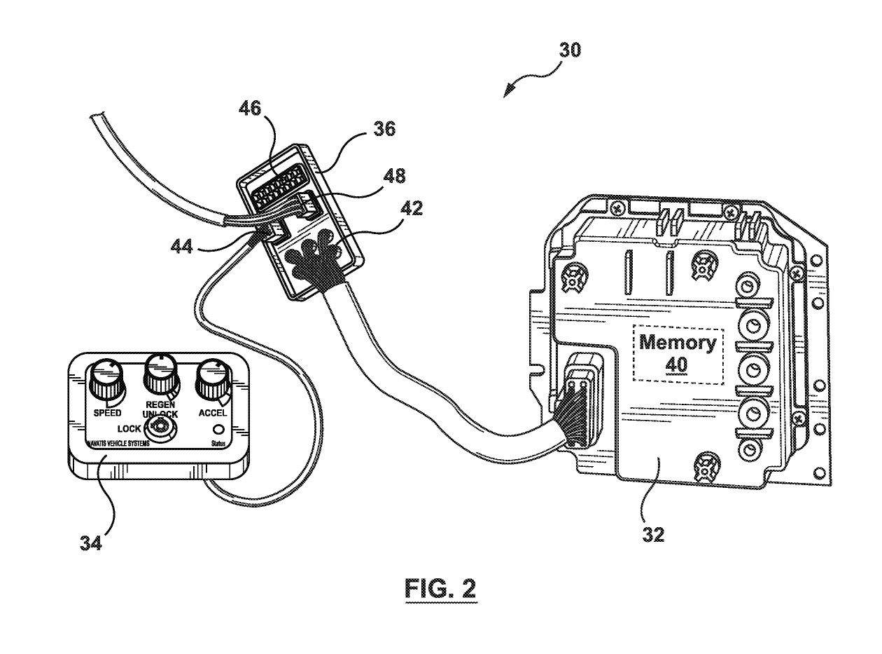

Referring now to FIG. 2, there is a kit 30 for retrofitting an electric vehicle such as the golf cart of FIG. 1. The kit 30 includes a replacement motor controller 32, and a driving parameter programmer 34 (also referred to as an “on-the-fly” (OTF) programmer). When installing the kit 30, the existing motor controller 18 may be removed and replaced by the replacement motor controller 32. The driving parameter programmer 34 may be installed in a location generally accessible to a driver such as near the steering wheel 28 or on the vehicle's dashboard.

The replacement motor controller 32 utilizes an adjustable motor control profile for operating the motor 14 and battery 16. The driving parameter programmer 34 is used to select driving parameters for adjusting the motor control profile. For example, the selectable driving parameters may include one or more of: acceleration limit, speed limit, regenerative braking limit, and vehicle range. Once the driving parameters are selected, the driving parameter programmer 34 sends the selected driving parameter information to the motor controller 32, and the motor controller 32 updates the motor control profile to adjust output to the motor 14 from the battery 16.

The motor controller 32 generally uses the motor control profile to control power to the motor 14 based on information received from the throttle 24 and brake 26. For example, the motor controller 32 may use the motor control profile to apply a particular voltage and current to the motor 14 based on how much the throttle 24 or brake 26 is depressed. Selecting certain driving parameters such as top speed may adjust the motor control profile to increase or decrease the amount of motor current and motor voltage supplied to the motor 14 for a given throttle position.

The motor controller 32 may be configurable for use with various battery capacities. For example, the motor controller 32 may have settings for selecting from a range of battery voltages such as 36V up to 72V.

Some vehicles have “series motors” where current flows through an armature and a stator in a series circuit. In these cases, particular adjustments to the motor current and the motor voltage would be applied to both the stator and armature.

Other vehicles have “separately excited motors” where the armature and stator are controlled independently by separate electric circuits (e.g. in parallel). For these separately excited motors, the motor controller 32 may separately adjust armature current and stator current; and may separately adjust armature voltage and stator voltage. In some embodiments, the motor controller 32 may apply armature current and stator current as a ratio of one another. In some examples, the ratio of armature current and stator current may be stored within a field map. For example, the motor control profile may include a three-dimensional variable field map that is a function of speed limit, armature current, and stator current.

In each case, the motor controller 32 updates the motor control profile to remain within motor operation limits associated with the golf cart 10. This may help avoid damaging components of the golf cart 10 such as the motor 14 or the battery 16. To facilitate this, the replacement motor controller 32 includes a memory 40 for storing motor operation limits corresponding to the golf cart 10. The motor operation limits may include limits for current and voltage applied to the motor 14. In some embodiments, the memory 40 of the motor controller 32 may store separate maximum and minimum limits for each of: armature current, armature voltage, stator current, and stator voltage. This may be particularly useful when controlling separately excited motors.

In some examples, the motor operation limits may be pre-set (e.g. the limits may be preset by a manufacture if the replacement motor controller 32 is designed for a particular golf cart). In other examples, the motor operation limits may be determined using a calibration procedure (described later below with respect to FIG. 7).

In some examples, the motor controller 32 may adjust the motor control profile over a particular time period to maintain the motor control profile within the motor operation limits. For example, the motor controller 32 may adjust the motor control profile based on a calculation of how much energy (e.g. current and voltage) has been applied to the motor 14 over a discretized period of time. This may help limit power surges, or otherwise protect the motor 14 from thermal damage.

In use, the replacement motor controller kit 30 allows drivers to select driving parameters in real-time while driving the golf cart 10. This means the desired operating characteristics of golf cart 10 can be adjusted in response to changing road conditions, changing tasks, or other changes in operating conditions. For example, when driving on a paved road, a driver might want to increase acceleration or top speed. Alternatively, when travelling long distances, a driver might want to increase regenerative braking or vehicle range. These changes can be made on-the-fly while driving the golf cart 10.

The ability to change operating conditions on-the-fly and in in real-time can help simplify “tuning” of the golf cart 10 in comparison to conventional motor controllers that previously relied on specialists and sophisticated equipment to make modifications. Furthermore, limiting parameter selection within motor operation limits can help reduce the possibility of damaging components of the golf cart 10 such as the motor 14 or the battery 16.

Referring still to FIG. 2, the driving parameter programmer 34 is in communication with the replacement motor controller 32. For example, there may be a wired or wireless connection between the driving parameter programmer 34 and the replacement motor controller 32. Moreover, the kit 30 may include a communication module for connecting the golf cart 10 to both the motor controller 32 and the driving parameter programmer 34. As shown in FIG. 2, the communication module may include a wiring harness adapter 36, which may have various connectors. For example, the wiring harness adapter 36 may include a controller connector 42 for connection to the replacement motor controller 32, a programmer connector 44 for connection to the driving parameter programmer 34, and a vehicle connector 46 for connection to various inputs and outputs of the golf cart 10 (such as the throttle 24, brake 26, and key switch). There might also be a second vehicle connector 48, which may be used for optional features such as four-wheel drive. Each connector 42, 44, 46 may have a particular pin configuration. In particular, the pin configuration of the vehicle connector 46 may be specific to the particular golf cart 10 that the kit 30 is being installed on. Accordingly, it may be desirable to supply a variety of wiring harness adapters in order to fit the specific wiring harnesses of a variety of golf carts.

While the illustrated embodiment shows a wiring harness adapter 36, in other embodiments the communication module may include a wireless communication device such as a WIFI or Bluetooth adapter. The wireless communication device may allow remote selection of driving parameters via a wireless connection. For example, the communication module may communicate with a mobile device such as a cell phone. In such examples, the mobile device may run a software application that provides similar functionality as the driving parameter programmer 34.

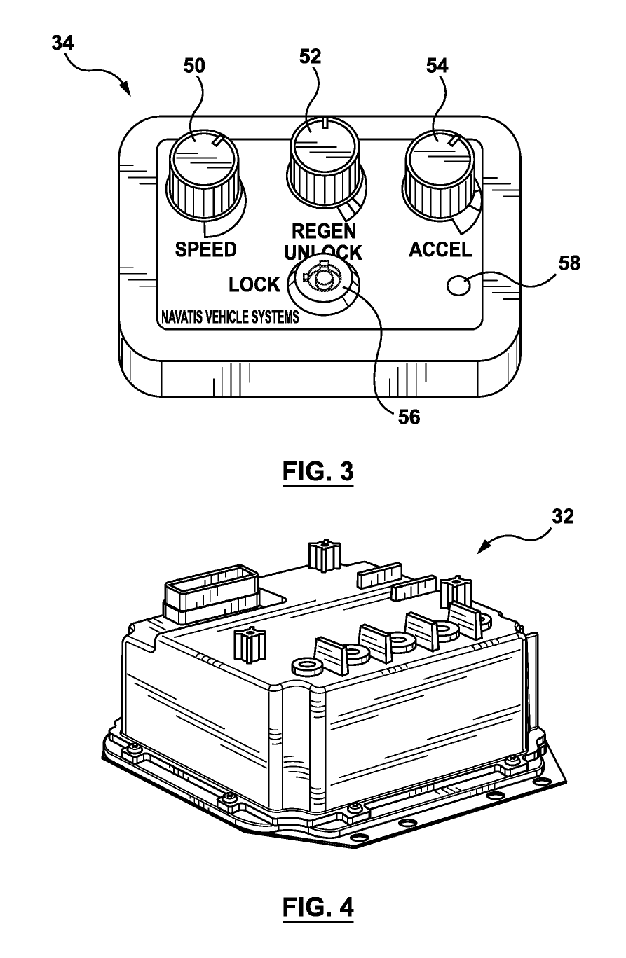

Referring now to FIG. 3, the driving parameter programmer 34 is used to select driving parameters associated with the golf cart 10. As described above, the selectable driving parameters may include acceleration limit, speed limit, regenerative braking limit, and vehicle range. Accordingly, the driving parameter programmer 34 may include a speed limit selector 50, a regenerative braking limit selector 52, and an acceleration limit selector 54. There may also be other selectors such as a vehicle range selector. One or more of the selectors 50, 52, 54 may have a variable input for selecting the driving parameter within a continuous range. For example, the selectors 50, 52, 54 may be dials for selecting the driving parameters within particular ranges.

In some embodiments, the kit 30 may include a lock-out device for restricting adjustments to the driving parameters. For example, the driving parameter programmer 34 may include a physical key lock 56 having a locked position for preventing adjustment to the driving parameters, and an unlocked position for allowing adjustment to the driving parameters. This may allow an operator to limit or prevent adjustment to certain driving parameters such as top speed. The lock-out device could also have other forms such as a passcode for enabling access to a software application on a mobile device. Furthermore, in some embodiments, the lock-out device could prevent operation of the golf cart 10. For example, a software application on a mobile device may have an option of disabling the motor controller 32. As another option, the key lock 56 could have a third position for disabling the key switch of the golf cart 10.

The driving parameter programmer 34 may include a visual indicator such as an LED 58. The LED 58 may output vehicle information such as status or error codes. More particularly, there may be key switch error codes, forward/reverse switch error codes, throttle error codes, and the like. In each case, the LED 58 may be configured to flash when a corresponding component is activated. For example, the LED 58 may be configured to flash when the key switch is turned on. If the LED 58 does not flash, it indicates that there might be a problem with the key switch.

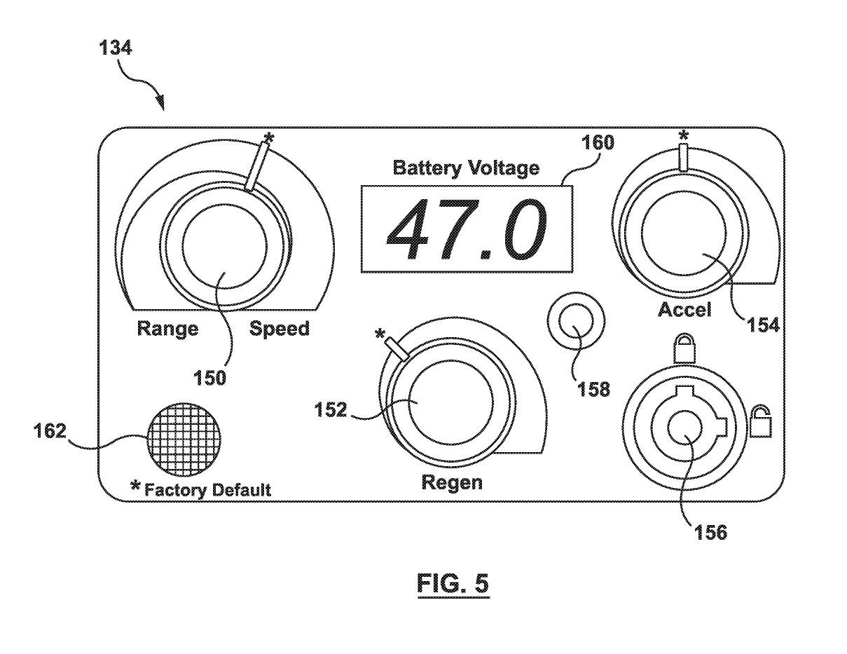

Referring now to FIG. 5, there is another example of a driving parameter programmer 134. The driving parameter programmer 134 may be similar in some respects to the driving parameter programmer 34. For example, the driving parameter programmer 134 may include selectors 150, 152, 154, and a lock-out device 156.

One difference is that the driving parameter programmer 134 is configured to output battery level information. The battery level information may be output as visible information, or audible information. For example, as shown, there is a battery level indicator 160 for outputting battery voltage and/or current levels. In other examples, an LED 158 (e.g. similar to LED 58) could be used to output battery level information visually as a battery discharge flash code. The driving parameter programmer 134 also includes a speaker 162 for outputting the battery level information in an audible format (e.g. a beep or buzzer may sound when battery power is low).

The driving parameter programmer 134 may also cooperate with the motor controller 32 to signal a low battery level (e.g. by flashing the LED 158 or providing an audible chirp through speaker 162). Signaling the low battery condition can help prevent damage to the batteries 16.

When a low battery level is detected, the motor controller 32 may adjust the motor controller profile to reduce power consumption. For example, the motor controller 32 may adjust the motor control profile to increase or maximize the motor's torque constant (Nm/Amp). This may increase the range of the golf cart 10 and may help protect the battery 16. In some cases, a user may be able to override this safety function (e.g. by cycling the key switch to return the golf cart 10 to a normal motor control profile for a short period of time).

The use of the audio and visual indicators such as LEDs 158, battery level indicator 160, and speaker 162 can help provide the driver with continuous diagnostics and operational feedback regarding the state of the golf cart 10. These indicators can signal the driver each time there is a notable change in the input commands being sent to the motor controller 32. For example, there may be audio or visual signals for throttle activation and brake activation, or signals indicating that battery level is low. In some embodiments, the speaker 162 could provide verbal notifications such as “low battery” message. Feedback could also be provided for forward commands, reverse commands, throttle start, throttle maximum, key switch on, and other input commands. In addition to providing real-time operational feedback, these signals can help identify defective components.

In some embodiments, the programmers 34 or 134 may have an external communication port such as a USB port. The external communication port may allow a mobile device to communicate with the motor controller 32. The external communication port could also be used to charge the mobile device.

Referring now to FIG. 6, there is a method 200 of controlling an electric vehicle such as the golf cart 10. The method 200 includes steps 210, 220, 230 and 240.

Step 210 includes identifying motor operation limits corresponding to the golf cart. For example, the motor operation limits may be retrieved from the memory 40 of the motor controller 32. As another example, the motor operation limits may be retrieved from the specific wiring harness of a particular vehicle. The motor operation limits identified may include motor current limits and motor voltage limits.

Step 220 includes selecting a driving parameter such as acceleration limit, speed limit, regenerative braking limit, or vehicle range. The driving parameter may be selected using the driving parameter programmers 34 or 134. Alternatively, the driving parameter may be selected using a mobile device such as a cell phone.

In some embodiments, the driving parameter may be selectable within a continuous range (e.g. using the parameter selectors 50, 52 and 54 of the driving parameter programmer 34).

Step 230 includes generating an adjustable motor control profile to operate the electric motor within the motor operation limits. For example, the motor controller 32 may update an adjustable motor control profile to adjust the amount of motor current or motor voltage to be applied to the stator and/or armature of the motor 14. Moreover, for a separately excited motor, a field map may be generated to define the ratio of electrical output between the stator and the armature (e.g. the ratio of stator current to armature current). Updates to the motor control profile may alter the throttle response and brake response. For example, the updated motor control profile may increase the acceleration rate for a given throttle position, or may increase the amount of regenerative braking when coasting or when applying the brake 26.

Step 240 includes applying the motor control profile in real-time to modify electrical output to the electric motor. For example, the motor control profile may be applied while driving the golf cart. In each case, the specific amount of motor current or motor voltage applied by the motor controller 32 is kept within the motor operation limits identified in step 210 (e.g. within the maximum and minimum voltage and current limits).

Referring now to FIG. 7, there is a method 300 for calibrating a replacement motor controller such as the controller 32 of the golf cart 10. The method 300 includes steps 310, 320, 330, 340, and 350.

Step 310 includes receiving throttle range data corresponding to operation of a throttle on the golf cart 10. For example, the wiring harness adapter 36 may be used to receive the throttle range data corresponding to when the throttle 24 is in an undepressed position and a fully depressed position.

Step 320 includes receiving brake range data corresponding to operation of a brake on the golf cart 10. For example, the wiring harness adapter 36 may be used to receive the brake range data corresponding to when the brake 26 is in an undepressed position and a fully depressed position.

In some embodiments, the throttle range data and the brake range data may be transmitted to the motor controller 32 as a voltage range (e.g. 0-10 V), or a current range (e.g. 4-20 mA). This data may be used in conjunction with the motor control profile to output particular current and voltage levels to the motors 14 depending on how far the throttle 24 or brake 26 is depressed.

Step 330 includes determining motor operation limits for the golf cart 10 based on the throttle range data and the brake range data. For example, the operational limits may include maximum and minimum limits for motor current and motor voltage. The motor operation limits may be determined by observing behavior of the motor 14 in response to actuation of the throttle and the brake.

As described above, the maximum and minimum limits may be different for “separately excited motors” and “series motors”. In particular, separately excited motors may have independent maximum and minimum limits for the stator voltage and current, as well as independent maximum and minimum limits for the armature voltage and current. For series motors, a single set of maximum and minimum limits may be determined for voltage and current.

In view of the above, the method 300 may include a step of selecting a calibration mode for either a series motor, or a separately excited motor. The particular calibration mode may be selected using one of the selectors 50, 52, or 54. For example, a calibration procedure may be entered by turning the key lock 56 back and forth five times. Furthermore, turning the regenerative braking limit selector 52 fully clockwise during the calibration procedure may select the series motor calibration mode. Alternatively, turning the regenerative braking limit selector 52 fully counter-clockwise may select the separately excited motor calibration mode.

Step 340 includes determining selection ranges for the driving parameters based on the motor operation limits. For example, the selectable ranges may be determined for one or more of: acceleration limit, speed limit, regenerative braking limit, and vehicle range. The selection ranges for each driving parameter may be determined based on the motor operation limits identified in step 330.

Step 350 includes storing the selectable driving parameters on the replacement motor controller. For example, the selectable driving parameters may be stored in the memory 40 of the motor controller 32.

The calibration mode selection procedure described above in step 330 may also be used for other settings. For example, turning the speed limit selector 150 fully clock-wise might disable audio or visual indicators such as the LED 58 or the speaker 162. As another example, turning the acceleration limit selector 54 fully clock-wise might disable motor protection.

While calibration procedures have been described for determining motor operation limits and selection ranges for the driving parameters, these and other calibration parameters may be loaded from other sources such as an external programmer, a vehicle wiring module, or the parameters may be loaded from a mobile device (e.g. via Bluetooth).

While the embodiments described above refer to electric golf carts, the embodiments herein could be used with other types of electric vehicles such as electrical utility vehicles and other small task-oriented vehicles.

While the above description provides examples of one or more apparatus, methods, or systems, it will be appreciated that other apparatus, methods, or systems may be within the scope of the claims as interpreted by one of skill in the art.

1. A kit for retrofitting a golf cart that has wheels driven by at least one electric motor, the kit comprising:
a) a replacement motor controller for operating the electric motor, the replacement motor controller including memory for storing motor operation limits corresponding to the golf cart; and
b) a driving parameter programmer in communication with the replacement motor controller for selecting a driving parameter that includes at least one of:
i) acceleration limit;
ii) speed limit;
iii) regenerative braking limit; and
iv) vehicle range;
wherein the replacement motor controller adjusts a motor control profile in real-time based on selection of the driving parameter, and the replacement motor controller maintains the motor control profile within the motor operation limits stored in the memory.

2. The kit of claim 1, wherein adjustments to the motor control profile include adjustments to motor current and motor voltage.

3. The kit of claim 2, wherein adjustments to the motor current include at least one of: armature current, and stator current; and wherein adjustments to the motor voltage include at least one of: armature voltage, and stator voltage.

4. The kit of claim 2, wherein the replacement motor controller has a separately excited motor configuration and the adjustments to the motor current include adjustments to a ratio of armature current and stator current.

5. The kit of claim 2, wherein the motor control profile includes a three-dimensional variable field map that is a function of speed limit, armature current, and stator current.

6. The kit of claim 1, wherein the motor operation limits stored on the replacement motor controller include at least one of: (a) motor current limits, and (b) motor voltage limits.

7. The kit of claim 1, wherein the replacement motor controller monitors power consumption over a time period and adjusts the motor control profile to maintain the motor control profile within the motor operation limits based on the power consumption detected over the time period.

8. The kit of claim 1, further comprising a communication module for connecting the replacement motor controller and the driving parameter programmer to the golf cart.

9. The kit of claim 8, wherein the communication module is selected from one of a plurality of communication modules, each of the plurality of communication modules having a wiring harness adapter for connection with a wiring harness of a particular golf cart.

10. The kit of claim 8, wherein the communication module includes a wireless communication device for remotely selecting the driving parameter.

11. The kit of claim 8, wherein the communication module includes a connector for providing four-wheel drive capability.

12. The kit of claim 1, further comprising a lock-out device for restricting adjustments to the driving parameter.

13. The kit of claim 1, wherein the replacement motor controller is configured to provide operational feedback as at least one of: (a) visible information, and (b) audible information.

14. The kit of claim 1, wherein the replacement motor controller is configured to output battery level information as at least one of: (a) visible information, and (b) audible information.

15. The kit of claim 1, wherein the replacement motor controller monitors for a low battery level, and adjusts the motor control profile to reduce power consumption when the low battery level is detected.

16. A method of controlling a golf cart having wheels driven by at least one electric motor, the method comprising:
a) identifying motor operation limits corresponding to the golf cart;
b) selecting a driving parameter that includes at least one of:
i) acceleration limit;
ii) speed limit;
iii) regenerative braking limit; and
iv) vehicle range;
c) generating a motor control profile to operate the electric motor within the motor operation limits; and
d) applying the motor control profile in real-time.

17. The method of claim 16, wherein the driving parameter is selectable within a continuous range in real-time while driving the golf cart.

18. The method of claim 16, wherein the motor control profile adjusts at least one of motor current and motor voltage.

19. A method for calibrating a motor controller of an electric golf cart, the method comprising:
a) receiving throttle range data corresponding to operation of a throttle on the electric golf cart;
b) receiving brake range data corresponding to operation of a brake on the electric golf cart;
c) determining motor operation limits for the electric golf cart based on the throttle range data and the brake range data;
d) determining a selection range for a driving parameter based on the motor operation limits, the driving parameter including at least one of:
i) acceleration limit;
ii) speed limit;
iii) regenerative braking limit; and
iv) vehicle range; and
e) storing the selection range for the driving parameter on the motor controller.

20. The method of claim 19, further comprising selecting a calibration mode for one of: (a) a series motor; and (b) a separately excited motor.
